(19) United States
(12) Patent Application Publication
(10) Pub. No.: US 2024/0296408 A1
(43) Pub. Date: Sep. 5, 2024

(54) BUSINESS IMPACT SCOPE PRESENTATION APPARATUS AND METHOD

(71) Applicant: Hitachi, Ltd., Tokyo (JP)

(72) Inventors: Shizhen HU, Tokyo (JP); Takashi TAMESHIGE, Tokyo (JP); Akira TANAKA, Tokyo (JP)

(21) Appl. No.: 18/239,820

(22) Filed: Aug. 30, 2023

(30) Foreign Application Priority Data
Mar. 2, 2023 (JP) 2023-031780

(51) Int. Cl. G06Q 10/0637

(52) U.S. Cl. CPC G06Q 10/06375

(57) ABSTRACT

A business impact scope presentation apparatus includes: a test log collection unit configured to collect test recording information indicating an implementation result of a test for monitoring target software in which one or more operational steps indicating content of each business and a plurality of microservices executing each operational step are connected via one or more request paths, and collect test case information indicating a relation between the content of each business and each operational step; a use case association unit configured to generate use case association information by associating the content of each business with a request path corresponding to each operational step based on the test recording information and the test case information; a monitoring information acquisition unit configured to acquire trace data indicating an implementation result of each microservice in a production environment; and a business impact scope analysis unit configured to determine whether an abnormality occurs.

### CROSS-REFERENCE TO RELATED APPLICATION

The present application claims priority from Japanese application JP2023-031780, filed on Mar. 2, 2023, the content of which is hereby incorporated by reference into this application.

### TECHNICAL FIELD

The present invention relates to a business impact scope presentation apparatus and a method.

### BACKGROUND ART

As microservices are spread, monitoring of systems becomes complicated. Since stake holders request determination materials for businesses, operational managers need to execute operational management in consideration of relations between operational targets and the businesses routinely. Therefore, technologies for specifying relations between systems and businesses from motions of the systems are required.

When such operational support methods are introduced, the operational managers need to define the relations between the systems and the businesses in advance, and thus it is assumed that the relations are understood. Therefore, the operational managers need to prepare for appropriate operations of the systems in cooperation with developers. When such operational support methods are introduced, the operational managers can normally confirm the relations between the systems and the businesses.

Here, PTL 1 discloses an operational support method of maintaining association information between an information technology (IT) system and a business, maintaining information regarding an important system for the business and a recovery level and a recovery procedure for continuing the business, and enabling countermeasures to be selected appropriately when an incident occurs.

### CITATION LIST

### Patent Literature

PTL 1: JP2020-160567A

### SUMMARY OF INVENTION

### Technical Problem

According to the method disclosed in PTL 1, by maintaining business functions of a business support system, an objective recovery level of a business, an attainment determination reference, and implementation factors in association with each other, it is possible to present countermeasures for attaining an objective recovery level when a business support system fails.

However, in the method disclosed in PTL 1, the countermeasures can be retrieved from the association information between previously ascertained business content and business functions of the business support system. Therefore, when the method disclosed in PTL 1 is applied to a microservice and when an abnormality such as performance deterioration or a failure occurs in an application programming interface (API) request path including a microservice and an API, it is difficult to specify business content impacted by the abnormality of the API request path.

An object of the present invention is to specify business content impacted by an abnormality of a request path when the abnormality occurs in a request path including a microservice.

### Solution to Problem

To attain the foregoing object, according to an aspect of the present invention, a business impact scope presentation apparatus includes: a test log collection unit configured to collect test recording information indicating an implementation result of a test for monitoring target software in which one or more operational steps indicating constituents of content of a plurality of businesses and a plurality of microservices executing processes through operations of the one or more operational steps are connected via one or more request paths, and collect test case information indicating a relation between the content of each of the businesses and each of the operational steps; a use case association unit configured to generate use case association information by associating the content of each of the businesses with a request path corresponding to each of the operational steps of the one or more request paths based on the test recording information and the test case information collected by the test log collection unit; a monitoring information acquisition unit configured to acquire trace data indicating an implementation result of each of the microservices as an implementation result in a production environment for the monitoring target software; and a business impact scope analysis unit configured to determine whether an abnormality occurs in one request path among the one or more request paths based on the trace data acquired by the monitoring information acquisition unit. When it is determined that the abnormality occurs in the one request path, the business impact scope analysis unit specifies the content of the business impacted by the request path in which the abnormality occurs among the content of each of the businesses with reference to the use case association information based on the request path in which the abnormality occurs.

### Advantageous Effects of Invention

According to the present invention, it is possible to specify business content impacted by an abnormality of a request path when the abnormality occurs in a request path including a microservice.

The other problems, configurations, and effects should be apparent in description of the following embodiments.

### BRIEF DESCRIPTION OF DRAWINGS

FIG. 1 is a block diagram illustrating a configuration example of a computer system including a business impact scope presentation apparatus according to Example 1 of the present invention.

FIG. 2 is a configuration diagram illustrating a configuration example of monitoring target software managed in a monitoring target system according to Example 1 of the present invention.

FIG. 3 is a functional block diagram illustrating a configuration example of the business impact scope presentation apparatus according to Example 1 of the present invention.

FIG. 4 is a configuration diagram illustrating a configuration example of a test case information according to Example 1 of the present invention.

FIG. 5 is a configuration diagram illustrating 10 configuration example of test recording information according to Example 1 of the present invention.

FIG. 6 is a configuration diagram illustrating a configuration example of use case association information according to Example 1 of the present invention.

FIG. 7 is a configuration diagram illustrating a configuration example of objective value information of a monitoring item according to Example 1 of the present invention.

FIG. 8 is a configuration diagram illustrating a configuration example of trace data according to Example 1 of the present invention.

FIG. 9 is a flowchart illustrating a processing example of the business impact scope presentation apparatus according to Example 1 of the present invention.

FIG. 10 is a configuration diagram illustrating an example of a display screen of a display apparatus according to Example 1 of the present invention.

FIG. 11 is a configuration diagram illustrating an example of another display screen of the display apparatus according to Example 1 of the present invention.

FIG. 12 is a flowchart illustrating a processing example of a business impact scope presentation apparatus according to Example 2 of the present invention.

FIG. 13 is a configuration diagram illustrating a configuration example of update information according to Example 3 of the present invention.

FIG. 14 is a flowchart illustrating a processing example of a business impact scope presentation apparatus according to Example 3 of the present invention.

### DESCRIPTION OF EMBODIMENTS

Hereinafter, embodiments of the present invention will be described with reference to the drawings. The following description and drawings are exemplary for describing the present invention and are omitted and simplified appropriately to clarify description. The present invention can be embodied in other various forms. The number of constituents may be singular or plural unless otherwise mentioned. Positions, sizes, shapes, ranges, and the like of constituents in the drawings may not be actual positions, sizes, shapes, ranges, and the like to facilitate understanding of the present invention. Therefore, the present invention is not necessarily limited to the positions, sizes, shapes, ranges, and the like disclosed in the drawings. In the following description, various types of information will be described in expressions of “tables”, “lists”, and the like, but various types of information may be expressed in data structures other than the tables, the lists, and the like. To indicate non-dependency on the data structures, “XX tables”, “XX lists”, and the like are referred to as “XX information” in some cases. When expressions such as “identification information”, “identifiers”, “names”, “IDs”, and “numbers” are used to describe identification information, these expressions can be replaced with each other.

### Example 1

In the present example, when an abnormality occurs in a request path including a microservice, business content impacted by the abnormality of the request path is specified from an implementation result under a production environment and an implementation result under a test environment of a monitoring target system that manages monitoring target software including a plurality of microservices defining processing content of one or more operational steps belonging to a plurality of businesses.

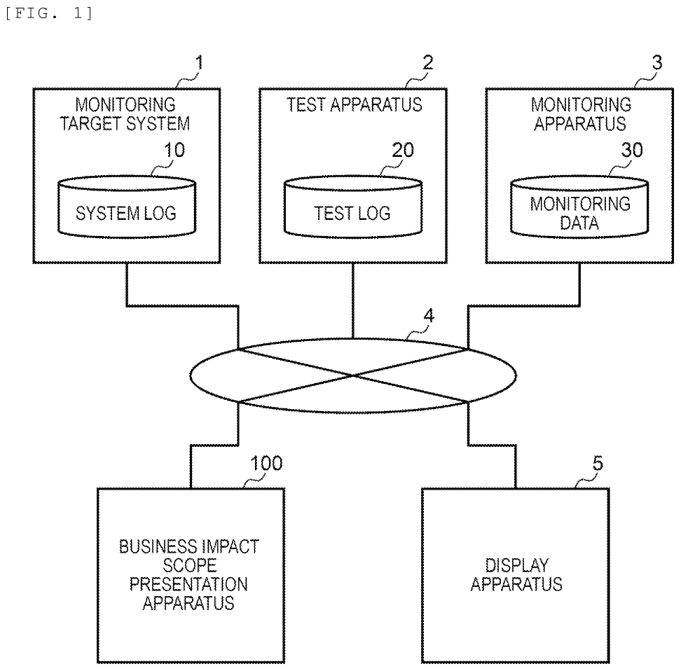

FIG. 1 is a block diagram illustrating a configuration example of a computer system including a business impact scope presentation apparatus according to Example 1 of the present invention. In FIG. 1, the computer system includes a monitoring target system 1, a test apparatus 2, a monitoring apparatus 3, a network 4, a business impact scope presentation apparatus 100, and a display apparatus 5. The business impact scope presentation apparatus 100 is connected to be able to communicate with the test apparatus 2, the monitoring apparatus 3, and the display apparatus 5 via the network 4. The network 4 is, for example, a public network such as the Internet, a local area network (LAN), a wide area network (WAN), or the like.

The monitoring target system 1 is an IT system that executes a business and is configured with, for example, a computer (not illustrated) that includes a processor, a storage device, an input device, an output device, and a communication device. The processor is configured with, for example, a central processing unit (CPU) or a micro processing unit (MPU). The processor executes a monitoring target program for executing a process in accordance with business content (hereinafter also referred to as a use case) of the IT system in a production environment. At this time, in a database 10 belonging to the storage device, data such as an error history or an access history generated while the processor executes the monitoring target program is stored as a system log. Means for storing the system log are not limited.

The test apparatus 2 is an apparatus that confirms whether the monitoring target system 1 is normally operating in a test environment before the monitoring target system 1 is introduced into the production environment and is configured with, for example, a computer (not illustrated) that includes a processor, a storage device, an input device, an output device, and a communication device. In a database 20 belonging to the storage device of the test apparatus 2, information indicating a test result (test recording information) when the monitoring target system 1 executes the monitoring target program in a test environment is stored as a test log. The test log is, for example, information for confirming whether a specific use case is normally realized and is used as information indicating whether an expected processing result or the like is obtained by what kind of operation. Means for storing the test log are not limited.

The monitoring apparatus 3 is an apparatus that collects various types of monitoring data from the monitoring target system 1 in the test environment and the production environment in order to confirm that the monitoring target system 1 is normally operating and is configured with, for example, a computer (not illustrated) that includes a processor, a storage device, an input device, an output device, and a communication device. In a database 30 belonging to the storage device of the monitoring apparatus 3, for example, metrics data such as a CPU use rate or a memory use rate, trace data including a path of an application programming interface (API) request (operating in any path), and a data log such as an access history or an error history are stored. Means for storing monitoring data are not limited.

The display apparatus 5 is, for example, an apparatus belonging to a server computer that is physical computer hardware owned by an operational management department of the IT system. The display apparatus 5 has information output from the business impact scope presentation apparatus 100 via the network 4 or a function of displaying a visualized chart attached to this information.

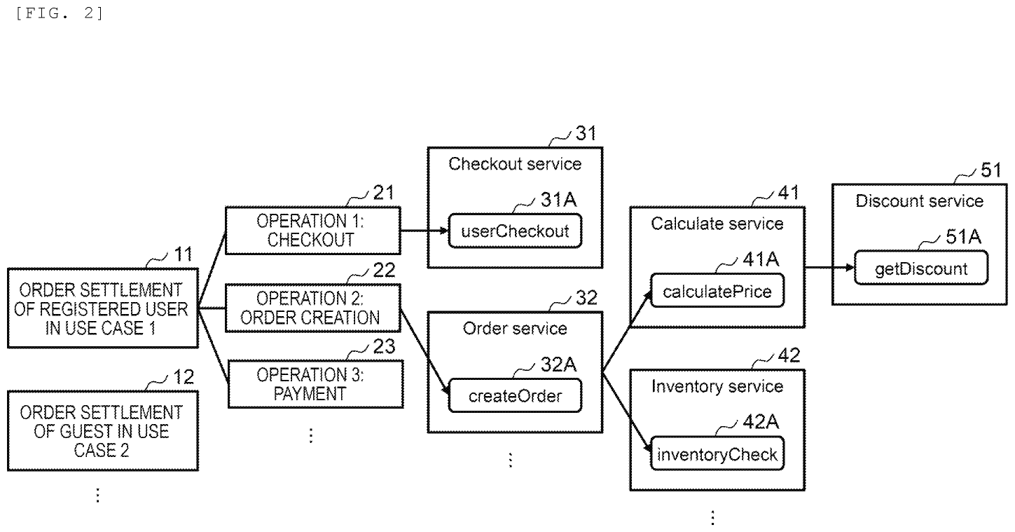

FIG. 2 is a configuration diagram illustrating a configuration example of monitoring target software managed in a monitoring target system according to Example 1 of the present invention. In FIG. 2, the monitoring target system 1 includes, as monitoring target software for executing a business of the IT system, use cases 11, 12, etc., operational steps 21, 22, 23, etc., microservices 31, 32, etc., microservices 41, 42, etc., a microservice 51, and API endpoints 31A, 32A, 41A, 42A, and 51A. The use cases 11 and 12 are business content desired to be realized by the IT system. For example, the use case 11 indicates that business content of the IT system is order settlement of a registered user and the use case 12 indicates that business content of the IT system is an order settlement of a guest. The operational steps 21, 22, and 23 are, for example, constituents belonging to the use case 11 and constituents when the use case 11 is classified into a plurality of cases according to its content. The operational step 21 is a step of operating a process for order settlement of a registered user and is, for example, checkout. The operational step 22 is a step of operating a process for order settlement of a registered user and is, for example, order creation. The operational step 23 is a step of operating a process for order settlement of a registered user and is, for example, payment.

The microservices 31, 32, 41, 42, and 51 are programs for providing functions of services and are independent programs. The microservice 31 is a program that has a function of executing the process for checkout. The microservice 32 is a program that has a function of executing the process for order creation. The microservice 41 is a program that has a function of executing a process for calculation. The microservice 42 is a program that has a function of executing a process for inventory check. The microservice 51 is a program that has a function of executing a process for coupon acquisition. The API endpoints 31A, 32A, 41A, 42A, and 51A are reception windows of the functions of the microservices 31, 32, 41, 42, and 51. One use case includes a plurality of operational steps. One operational step is executed via one or more microservices and API endpoints.

That is, in order to execute a process for one operational step, the one operational step is connected to an input/output interface of a request (access) belonging to any microservice or API endpoint. For example, the operational step 21 connected to the use case ! is connected to the API endpoint 31A of the microservice 31. The operational step 22 connected to the use case 11 is connected to the endpoint 51A of the microservice 51 via the API endpoint 32A of the microservice 32 and the API endpoint 41A of the microservice 41 and is connected to the API endpoint 32A of the microservice 32 and the API endpoint 42A of the microservice 42. At this time, each microservice and each API endpoint form an API request path indicating a transmission path of a request (access) from any microservice (client) to another microservice (server).

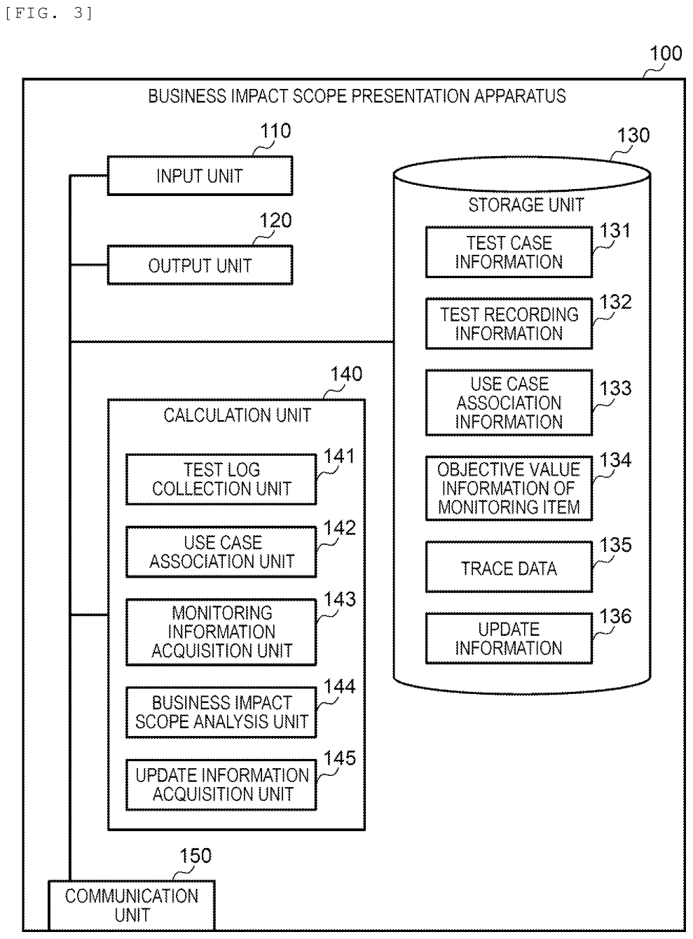

FIG. 3 is a functional block diagram illustrating a configuration example of the business impact scope presentation apparatus according to Example 1 of the present invention. In FIG. 3, the business impact scope presentation apparatus 100 includes, for example, an input unit 110, an output unit 120, a storage unit 130, a calculation unit 140, and a communication unit 150 as software resources. The business impact scope presentation apparatus 100 is configured with a computer (not illustrated) that includes a processor, a main storage device, an auxiliary storage device, an input device, an output device, and a communication device as hardware resources.

The main storage device is a device that stores a computer program or data and is, for example, a read only memory (ROM), a random access memory (RAM), a nonvolatile semiconductor memory, or the like.

The auxiliary storage device is, for example, a reading/writing device for a recording medium such as a hard disk drive, a solid state drive (SSD), an optical storage medium (that is, a compact disc (CD), a digital versatile disc (DVD), or the like), a storage system, an integrated circuit card (IC card), or a secure digital (SD) memory card, a storage area of a cloud server, or the like. The computer program or the data stored in the auxiliary storage device is read to the main storage device at any time.

The input device is, for example, a keyboard, a mouse, a touch panel, a card reader, an audio input device, or the like. The output device (display apparatus) is a user interface that provides various types of information such as a processing progress and a processing result to a user. The output device is, for example, a screen display device (that is, a liquid crystal monitor, a liquid crystal display (LCD), a graphic card, or the like) serving as a display, an audio output device (that is, a speaker or the like), or a printing apparatus.

The communication device is a wired or wireless communication interface that realizes communication with another device via communication means such as a LAN or the Internet. The communication device is, for example, a network interface card (NIC), a wireless communication module, a universal serial bus (USB) module, a serial communication module, or the like.

Here, the processor is configured with, for example, a CPU or an MPU. At this time, for example, the processor operates in accordance with an input program loaded to the main storage device to realize a function of the input unit 110 and operates in accordance with an output program loaded to the main storage device to realize a function of the output unit 120. The processor operates in accordance with a calculation program loaded to the main storage device to realize a function of the calculation unit 140 and operates in accordance with a communication program loaded to the main storage device to realize a function of the communication unit 150. Further, the processor operates using the main storage device as a target that stores data or information to realize a function of the storage unit 130.

Specifically, the input unit 110 inputs information generated when a user operates a keyboard or a mouse, via an input device, receives the input information as input information, and outputs the input information to the calculation unit 140.

The output unit 120 generates screen information or the like to be displayed on a display (display unit) of the business impact scope presentation apparatus 100 or the display apparatus 5 and outputs the generated image information to the display or the display apparatus 5.

The storage unit 130 is a database that stores various types of information. The storage unit 130 stores test case information 131, test recording information 132, use case association information 133, objective value information 134 of a monitoring item, trace data 135, and update information 136. Hereinafter, information stored in the storage unit 130 will be described. The calculation unit 140 and the communication unit 150 will be described below.

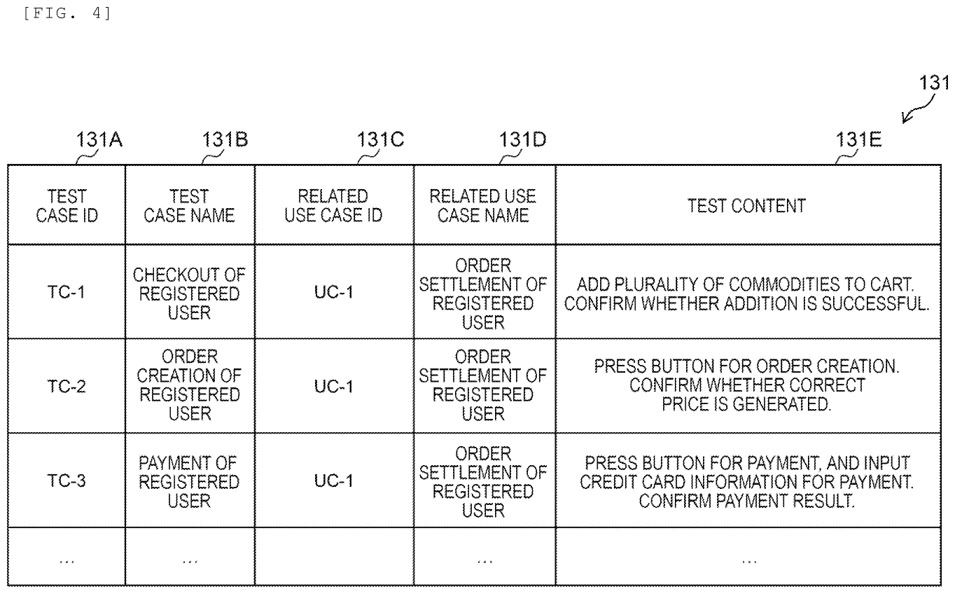

FIG. 4 is a configuration diagram illustrating a configuration example of a test case information according to Example 1 of the present invention. In FIG. 4, the test case information 131 is information that is generated in advance by the test apparatus 2 as information necessary for the test apparatus 2 to execute a test on the monitoring target system, and includes a test case ID 131A, a test case name 131B, a related use case ID, a related use case name 131D, and test content 131E.

The test case ID 131A is an identifier for uniquely identifying a test case number. In the test case ID 131A, for example, information “TC-1” is recorded as a first number of a test case. The test case name 131B is an identification name for identifying a name of the test case. In the test case name 131B, “Checkout of registered user” is recorded, for example, when a checkout test for a registered user (a test indicating processing content of the operational step 21 of FIG. 2) is executed. The related use case ID is an identifier for uniquely identifying a use case number desired to be verified in the test case. In the related use case ID, information “UC-1” is recorded, for example, when a use case (order settlement of the registered user) number desired to be verified in the test case is “UC-1”. The related use case name 131D is an identification name of a use case desired to be verified in the test case. In the related use case name 131D, information “Order settlement of registered user” is recorded, for example, when a use case desired to be verified in the test case (TC-1) is order settlement (the use case 11 of FIG. 2) of the registered user. The test content 131E is content of a test by the test apparatus 2. In the test content 131E, for example, information “add plurality of commodities to cart. confirm whether addition is successful.” is recorded as a motion and output expected as an operation and an input to the monitoring target system 1 which is a test target.

Here, for example, in the case of the test case (TC-1), “In test case of test number TC-1, use case of use case number UC-1 is verified. Test is completed when a plurality of commodities are added to cart and screen of addition success can be confirmed” is recorded.

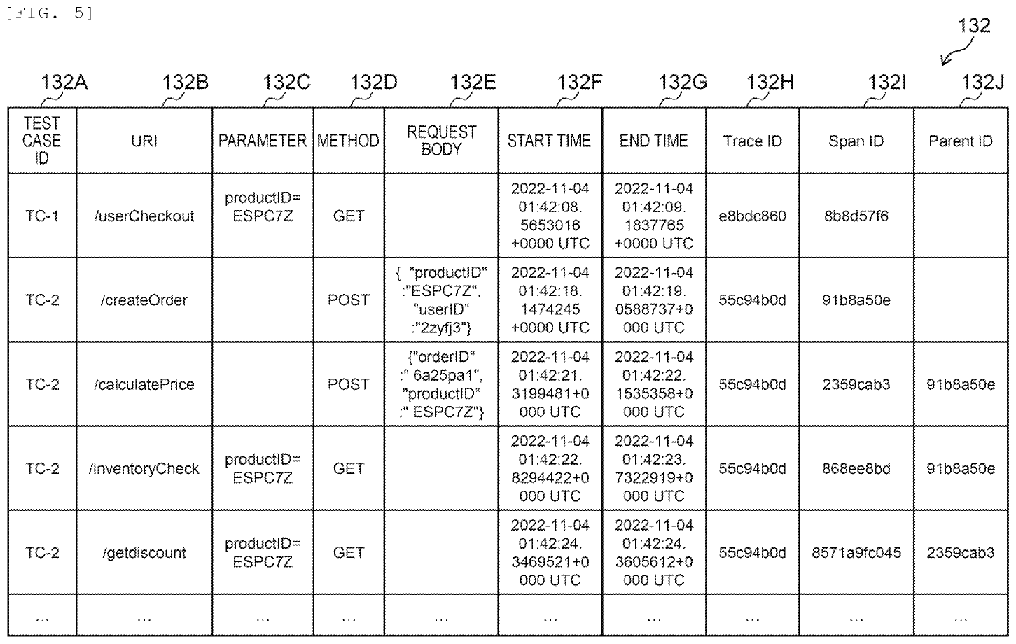

FIG. 5 is a configuration diagram illustrating a configuration example of test recording information according to Example 1 of the present invention. In FIG. 5, the test recording information 132 is information recorded by collecting a test result when the test apparatus 2 executes a test on the monitoring target system 1, and includes a test case ID 132A, a uniform resource identifier (URI) 132B, a parameter 132C, a method 132D, a request body 132E, a start time 132F, an end time 132G, a trace ID 132H, a span ID 1321, and a parent ID 132J.

The test case ID 132A is a test case number like the test case ID 131A. The URI 132B is a path of a designated endpoint when the monitoring target system 1 executes a test. In the URI 132B, information “/userCheckout” is recorded as a path of an endpoint (API endpoint 31A), for example, when the monitoring target system 1 executes the test in the test case (TC-1). The parameter 132C is additional information that is added in a specific format to the end of a path for designating a destination of a request (access) when the monitoring target system 1 executes the test. In the parameter 132C, information “product ID=ESPC7Z” is recorded, for example, when the path of the endpoint (API endpoint 31A) is “/userCheckout”. The method 132D indicates a type of request to a server that is a transmission destination of a request by a client (a request transmission source) in conformity with a communication protocol hypertext transfer protocol (HTTP). In the method 132D, for example, information “GET” is recorded as a request from the client to the server. The request body 132E is information transmitted from the client to the server. When the method 132D is “GET”, no information is recorded in the request body 132E.

The start time 132F is a time at which a specific request is transmitted from the client to the server. In the start time 132F, at least information “20Nov. 11, 2004 01:42:08, 5653016” is recorded, for example, when a start time is 01:42:08 on Nov. 4, 2022. The end time 132G is a time at which the server completes a process and a response is transmitted to the client. In the end time 132G, at least information “2022-11-04 01:42:09, 1837765” is recorded, when an end time is 01:42:09 on Nov. 4, 2022. At this time, a time from the start time 132F to the end time 132G is a processing time required in a process for a request by the client. In the start time 132F and the end time 132G, a time of ms orders can also be recorded as a time less than a second.

The trace ID 132H is an identifier for identifying a series of requests when the requests are made from the client to the API endpoint. In the trace ID 132H, for example, in the case of the test case (TC-1), information “e8bdc860” is recorded as an identifier of a request when the request is made from the client to the API endpoint 31A.

The span ID 1321 is an identifier for identifying processing content of an endpoint when a request is transmitted from the client to the API endpoint. In the span ID 132I, information “8b8d57f6” is recorded as an identifier for identifying a process of the API endpoint 31A, for example, when a request is transmitted from the client to the API endpoint 31A. The parent ID 132J is an identifier for identifying a process of an immediately previous request directly made from the client to the API endpoint among the requests when the requests are transmitted from the client to the API endpoint. In the parent ID 132J, for example, in the case of the test case (TC-1), there is no immediately previous request in the requests made from the client to the API endpoint 31A. Therefore, no information is recorded. In the case of a test case (TC-2), information “91b8a50e” is recorded as an identifier (an identifier for identifying a process of the API endpoint 32A) for identifying a process of an immediately previous request in a record in which “/calculatePrice” is recorded in the URI 132B in the parent ID 132J.

Here, for example, in the case of the use case 11 indicating “Order settlement of registered user”, the fact that a process for “checkout” which is an operation of the operational step 21 of the test case TC-1 is executed using the API endpoint 31A of the microservice 31 indicating “Checkout service” is recorded. The fact that a process for “order creation” which is an operation of the operational step 22 of the test case TC-2 is executed using the API endpoint 32A of the microservice 32 indicating “Order service”, the API endpoint 41A of the microservice 41 indicating “Calculate service”, the API endpoint 42A of the microservice 42 indicating “Inventory service”, and the API endpoint 51A of the microservice 51 indicating “Discount service” is recorded.

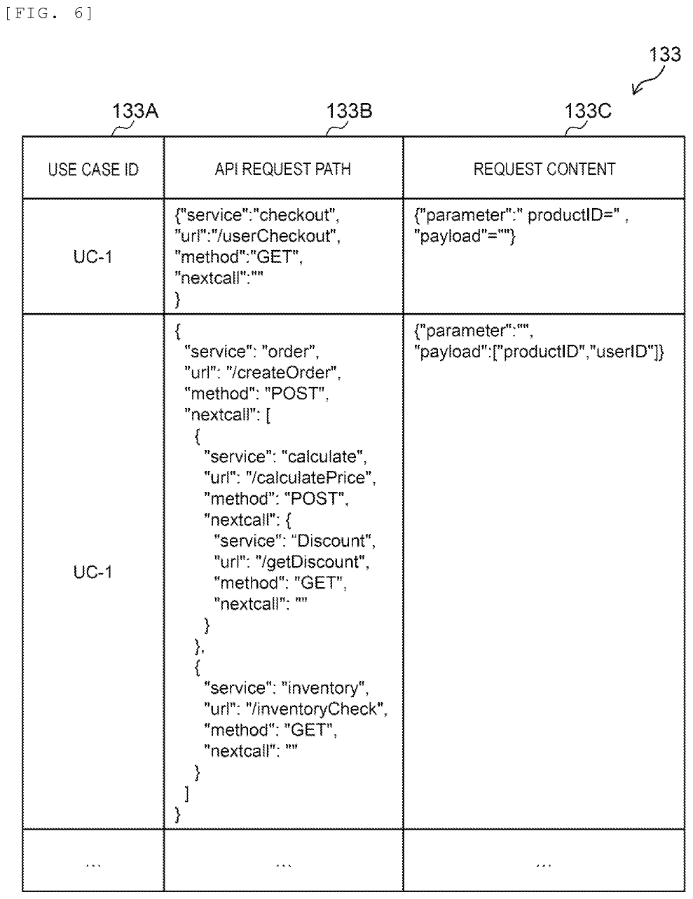

FIG. 6 is a configuration diagram illustrating a configuration example of use case association information according to Example 1 of the present invention. In FIG. 6, the use case association information 133 is information generated by the test apparatus 2 to associate a use case with an API request path and includes a use case ID 133A, an API request path 133B, and request content 133C.

The use case ID 133A is an identification number for uniquely identifying a use case. In the use case ID 133A, information “UC-1” is recorded, for example, in the case of the use case 11 indicating “Order settlement of registered user”. The API request path 133B is a path of a request transmitted from the client to the server when the use case is executed. In the API request path 133B, when the request is processed via one or more API endpoints, microservices through the request passes, a path of the API endpoints, and information regarding an HTTP method are recorded in, for example, a JavaScript (registered trademark) object notation (JSON) format. The request content 133C is content of a request transmitted from the client to the server. In the request content 133C, a parameter which a first request has or structure information of a request body is recorded in, for example, the JSON format on an API request path.

Here, for example, when the use case ID 133A is “UC-1”, a fact that a first operation related to the use case is executed by “calling/userCheckout API endpoint of a checkout microservice and using productID as a parameter in a GET method” is indicated.

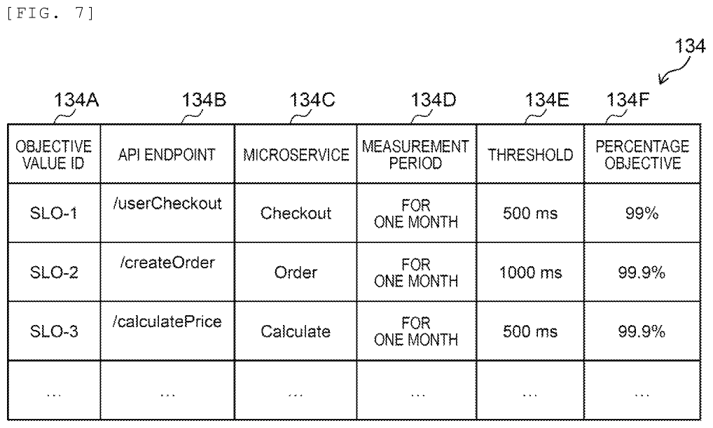

FIG. 7 is a configuration diagram illustrating a configuration example of objective value information of a monitoring item according to Example 1 of the present invention. In FIG. 7, the objective value information 134 of the monitoring item is information generated by the monitoring apparatus 3 as information including an available objective and a performance objective to be attained by the API and includes an objective value ID 134A, an API endpoint 134B, a microservice 134C, a measurement period 134D, a threshold 134E, and a percentage objective 134F.

The objective value ID 134A is an identification number for identifying an objective value of a monitoring index and a measurement scheme of an API which is a monitoring target (a monitoring target API) of the monitoring apparatus 3. In the objective value ID 134A, for example, as Number 1 of “service level objective” (SLO), information “SLO-1” is recorded. The API endpoint 134B is an API endpoint of a monitoring target API of the monitoring apparatus 3. In the API endpoint 134B, information “/userCheckout” is recorded, for example, in the case of the API endpoint 31A. The microservice 134C is a name of a microservice to which the monitoring target API belongs. In the microservice 134C, information “Checkout” is recorded, for example, when a microservice to which the monitoring target API belongs is the microservice 31.

The measurement period 134D is a calculation period of a monitoring index (for example, a processing time necessary in a process for a request) of the monitoring target API necessary to calculate the percentage objective 134F. In the measurement period 134D, information “For one month” is recorded, for example, when the calculation period is one month. The threshold 134E is a reference value for determining whether the monitoring index of the monitoring target API is normal or abnormal. In the threshold 134E, information “500 ms” is recorded, for example, when a processing time necessary in the process for the request is used as the monitoring index of the monitoring target API. At this time, when the processing time necessary in the process for the request is “500 ms” or less, it is determined that the monitoring index is normal. When the processing time exceeds “500 ms”, it is determined that the monitoring index is abnormal. The percentage objective 134F is an objective value indicating a ratio of measurement values determined to be normal to all measured values obtained during a given period as measured values of the monitoring target API. In the percentage objective 134F, information “99%” is recorded, for example, when an objective value of the normal measured values among all the measured values is 99%.

Here, for example, when the objective value ID 134A is “SLO-1”, “Requests ended at 500 ms or less occupy 99% or more of all the requests received for one month by the/userCheckout API endpoint of the checkout microservice” is indicated as an objective value.

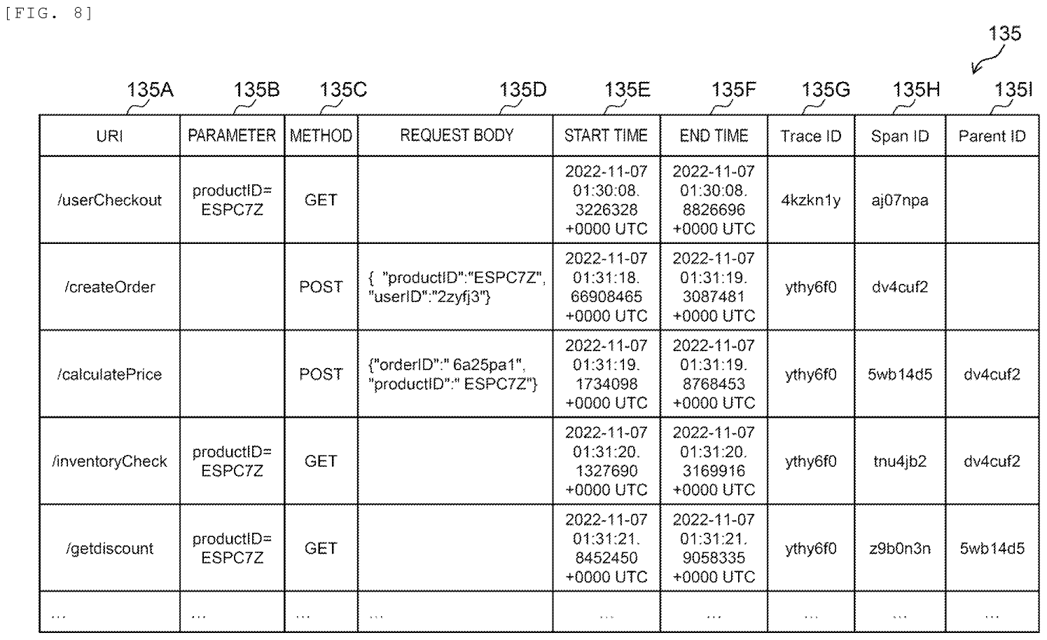

FIG. 8 is a configuration diagram illustrating a configuration example of trace data according to Example 1 of the present invention. In FIG. 8, the trace data 135 includes data collected from the monitoring target system 1 by the monitoring apparatus 3 during an operation of the monitoring target system 1, and has information such as a URI 135A, a parameter 135B, a method 135C, a request body 135D, a start time 135E, an end time 135F, a trace ID 135G, a span ID 135H, and a parent ID 135I.

The URI 135A is a designated endpoint path when the test case is executed and is similar to the URI 132B of FIG. 5. The parameter 135B is additional information added in a specific format to the end of a path for designating a destination of a request and is similar to the parameter 132C of FIG. 5. The method 135C indicates a type of request from a client to a server in conformity with HTTP and is similar to the method 132D of FIG. 5. The request body 135D is information transmitted from the client to the server and is similar to the request body 132E of FIG. 5. The start time 135E is a time at which a specific request is transmitted to the server and is similar to the start time 132F of FIG. 5. In the start time 135E of a first record, information “2022-11-07 01:30:08, 3226328” is recorded. The end time 135F is a time at which the server completes a process and a response is transmitted from the server to the client and is similar to the end time 132G of FIG. 5. In the end time 135F of the first record, information “2022-11-07 01:30:08, 8826696” is recorded. A time from the start time 135E to the end time 135F is a processing time required in a process for a request by the client (an operational step or a microserver). In the start time 135E and the end time 135F, a time of ms orders can also be recorded as a time less than a second.

The trace ID 135G is an identifier for identifying a series of requests when the requests are made from the client to the API endpoint and is similar to the trace ID 132H of FIG. 5. In the trace ID 135G of the first record, information “4kzknly” is recorded. The span ID 135G is an identifier for identifying processing content of an endpoint when a request is transmitted from the client to the API endpoint and is similar to a span ID 1321 of FIG. 5. In the span ID 135G of the first record, information “aj07npa” is recorded. The parent ID 135I is an identifier for identifying a process of an immediately previous request directly made from the client to the API endpoint among the requests when the requests are transmitted from the client to the API endpoint and is similar to the parent ID 132J of FIG. 5.

Here, for example, the case of the first record indicates that “an operation on the/userCheck API endpoint started from 2022-11-07 01:30:08, 3226328 is executed in a GET method with a parameter proeudctID=ESPC7Z and is ended at 2022-11-07 01:30:08, 8826696. The trace ID of this operation is 4kzknly and the span ID is aj07npa”.

Next, referring back to FIG. 3, a specific configuration of the calculation unit 140 will be described. The calculation unit 140 includes, for example, a test log collection unit 141, a use case association unit 142, a monitoring information acquisition unit 143, a business impact scope analysis unit 144, and an update information acquisition unit 145.

The test log collection unit 141 is a test log collection program that collects the test case information 131 and an implementation result of a test from the test apparatus 2 and acquires monitoring data collected at the time of execution of the test from the monitoring apparatus 3. Specifically, the test log collection unit 141 reads and collects the test case information 131 illustrated in FIG. 4 as test case information indicating a relation between each use case and each test case (operational step) from the test apparatus 2 via the network and stores the collected test case information 131 in the storage unit 130. When the test apparatus 2 executes a test on the monitoring target system 1 and the monitoring apparatus 3 collects monitoring data from the monitoring target system 1, the test log collection unit 141 reads, for example, the trace data 135, the objective value information 134 of the monitoring item, a response time (processing time) of each request, and the like as the monitoring data from the monitoring apparatus 3, generates the test case information 132 illustrated in FIG. 5 with reference to the read monitoring data and the test recording information 131, and stores the generated test recording information 132 in the storage unit 130.

Here, a method of acquiring the test case information 131 is not limited to the exemplified method. For example, the test case information 131 may be acquired from a continuous integration/continuous delivery (CI/CD) tool (for example, a tool such as Jenkins or CircleCI) managed by the test apparatus 2. A specific name and test content may be acquired from another data source using a test case ID (for example, UC-1) and a use case ID (for example, UC-1) as keys. A method of acquiring a test log is not limited to the exemplified method. A method of acquiring the test log using an API of the monitoring apparatus 3 may be used.

The use case association unit 142 is a use case association program that patterns API requests based on the test recording information 132 generated by the test log collection unit 141 and extracts a relation between the API requests and the use cases. Specifically, the use case association unit 142 acquires an implementation result (for example, test recording information) of the test and monitoring data (for example, trace data), extracts each of a series of microservices, API endpoints, and request content of the same operation (all the API requests belonging to the same trace ID subordinate) from the acquired information and data, and generates nested information. At this time, the use case association unit 142 generates the nested information as the use case association information 133 illustrated in FIG. 6 and stores the generated use case association information 133 in the storage unit 130. That is, the use case association unit 142 generates the use case association information 133 in association with each use case and a request path corresponding to each operational step among one or more request paths. A process of extracting the relation between the API requests and the use cases will be described below.

The monitoring information acquisition unit 143 is a monitoring information acquisition program that acquires, from the monitoring apparatus 3, the objective value information 134 and the monitoring data, for example, trace data indicating an implementation result of a microservice as an implementation result of the monitoring target software managed in the monitoring target system 1 in a production environment, of the monitoring item. Specifically, the monitoring information acquisition unit 143 acquires information regarding objective values (a measurement period, a threshold, and a percentage objective) at which a monitoring item of each monitoring target API is to be attained from a setting file of the monitoring apparatus 3 and acquires the trace data (the URI, the parameter, the method, the request body, the start time, the end time, the trace ID, the span ID, and the parent ID) belonging to the monitoring data of the monitoring apparatus 3. At this time, the monitoring information acquisition unit 143 stores information regarding the objective values at which the monitoring item of each monitoring target API is to be attained as the objective value information 134 of the monitoring item illustrated in FIG. 7 in the storage unit 130 and stores the acquired trace data as the trace data 135 illustrated in FIG. 8 in the storage unit 130.

The business impact scope analysis unit 144 is a business impact scope analysis program that determines whether an abnormality including performance deterioration or occurrence of a failure occurs in any request path among the plurality of request paths based on the trace data, compares the use case association information 133 illustrated in FIG. 6 with the trace data 135 illustrated in FIG. 8, and associates the API request path in which the objective value is not achieved with the use case. Specifically, the business impact scope analysis unit 144 compares an API request in which the objective value is not achieved, for example, a feature of an API request in which a processing time of a request exceeds “500 ms”, with a pattern of the API request path recorded in the use case association information 133 and retrieves a use case in which there is an API request path matching the API request in which the objective value is not achieved in the use case association information 133. The retrieving process will be described below.

The communication unit 150 is a communication program that transmits and receives information to and from an external apparatus. Specifically, the communication unit 150 acquires necessary data from the test apparatus 2 and the monitoring apparatus 3. The communication unit 150 transmits an instruction to generate a user interface (UI) of an information input as screen information to the display apparatus 5.

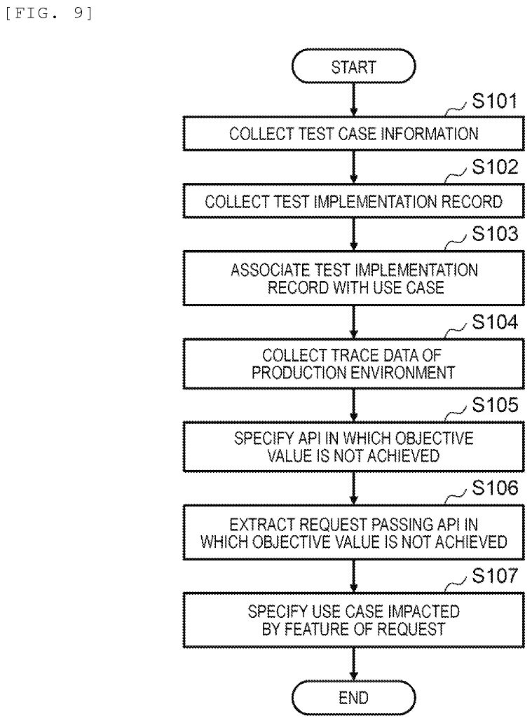

FIG. 9 is a flowchart illustrating a processing example of the business impact scope presentation apparatus according to Example 1 of the present invention. The process is executed by the business impact scope presentation apparatus 100, for example, when an instruction to execute a process is received from the display apparatus 5 via the input unit 110.

When the business impact scope presentation apparatus 100 starts a process of identifying an impact scope, the business impact scope presentation apparatus 100 collects the test case information 131 from the test apparatus 2 (step S101). Specifically, the test log collection unit 141 collects the test case information 131 from the test apparatus 2 in order to collect information for defining the relation between the test cases and the use cases and stores the collected test case information 131 in the storage unit 130. At this time, in the test case information 131, the use case “UC-1” includes three test cases (“TC-1”, “TC-2”, and “TC-3”) and each test content is recorded for each test case.

Subsequently, the business impact scope presentation apparatus 100 collects an implementation record of the test in which the test apparatus 2 executes on the monitoring target system 1 (step $102). Specifically, the test log collection unit 141 collects a record of monitoring data (trace data or the like) collected from the monitoring apparatus 3 during a test implementation period and generates the test recording information 132. At this time, the test log collection unit 141 includes information (test case ID) of the test case in the test recording information 132 including the test log in order to collate test implementation content with the monitoring data (trace data) with a time (time stamp). For example, in the test recording information 132, in the case of the test case of “TC-2”, when a request is made to an API endpoint of/createOrder of the microservice Order service, the request body includes “product ID” and “user ID”, a feature indicating that the request is executed via the plurality of microservices and API endpoints (API request path) is recorded.

Here, a method of collating the test case with the monitoring data (trace data) of the test implementation result is not limited to the exemplified method. For example, the test case and the monitoring data (trace data) of the test implementation result may be specified with a URI of a test target API endpoint.

Subsequently, the business impact scope presentation apparatus 100 associates the test implementation record recorded in the test recording information 132 with the use case (step S103). Specifically, the use case association unit 142 groups all the API requests associated with a specific use case in units of trace IDs from the information (test log) recorded in the test case information 131 and the information recorded in the test recording information 132, extracts a feature of a request group of each trace ID, and generates the use case association information 133. For example, the use case association unit 142 extracts an API request path (a path in which a process is completed via API/calculatePrice of calculate service, API/getDiscount of discount service, and/inventoryCheck of inventory service from API/createOrder from order service) and request content (there are a product ID and a user ID in a payload) based on the API request (trace ID: 55c94b0d) of the test case “TC-2” associated with the use case of “UC-1” and generates the use case association information 133 with the format illustrated in FIG. 6 from the extracted API request path and the request content.

Here, a data item and an extraction method which are features of the requests are not limited to the exemplified method. For example, features other than the API request path and the request content may be adopted as long as the requests cannot be uniquely specified.

Subsequently, the business impact scope presentation apparatus 100 collects the monitoring data of the production environment from the monitoring apparatus 3 (step S104). Specifically, the monitoring information acquisition unit 143 collects the monitoring data including the features (the URI, the parameter, the method, the request body, the start time, the end time, the trace ID, the span ID, and the parent ID) of each API request from the monitoring apparatus 3, generates the trace data 135 with the format illustrated in FIG. 8, and stores the generated trace data 135 in the storage unit 130.

Subsequently, the business impact scope presentation apparatus 100 specifies an API in which an objective value is not achieved (step S105). Specifically, the business impact scope analysis unit 144 determines whether the objective value of the API is not achieved at a ratio of requests in which expected performance is less than a threshold during a given period. For example, the business impact scope analysis unit 144 monitors a motion of the monitoring target system 1. When it is found that performance of the API “/calculatePrice” is less than an objective value, “/calculatePrice” is specified by analyzing alert information or the monitoring data from the monitoring apparatus 3.

Here, a method of specifying the API in which a monitoring objective value is not achieved is not limited to the exemplified method. For example, a distinctive determination reference may be used in each development project in accordance with a nature of the monitoring target system 1.

Subsequently, the business impact scope presentation apparatus 100 extracts a request passing through the API in which the objective value is not achieved (step S106). Specifically, the business impact scope analysis unit 144 extracts all the requests passing through a target API endpoint which is an alert target based on the trace data and specifies an impacted request with a threshold of the objective value information 134 of the monitoring item among all the extracted requests. For example, all the requests passing through the API endpoint in which the URI is/calculatePrice are retrieved from the trace data. Of all the requests passing the API endpoint in which the URI is/calculatePrice, a request in which a processing time of/calculatePrice exceeds a threshold of 500 ms (the threshold 134E recorded in the objective value information 134 of the monitoring item) is specified and recorded as an impacted request (a request in which the processing time exceeds the threshold).

Subsequently, the business impact scope presentation apparatus 100 specifies a use case impacted by a feature of a request (API request) (step S107). Specifically, the business impact scope analysis unit 144 compares a feature (the trace data 135) of the API request with a feature of the API request recorded in the use case association information and determines that the corresponding use case is “impacted” for the requests of which the content of both the features completely matches each other. For example, referring to the trace data 135 which is a feature of the API request, the request can be understood to be an impacted request from the request record of the trace ID “ythy6f0” in the trace data 135 when the processing time of/calculatePrice exceeds the threshold of 500 ms. The API request path and the content of the API request among the API requests specified with the trace ID “ythy6f0” in the trace data 135 match all the API request path 133B and the content recorded in the request content 133C of the use case association information 133. Accordingly, it can be understood that the use case “Order settlement of registered user” of “UC-1” is impacted by a request in which the processing time of/calculatePrice exceeds the threshold of 500 ms.

Here, a method of comparing the features of the API requests is not limited to the exemplified method. For example, a method of clustering the requests using the features of the API requests and displaying the requests in a distance order may be used. Since there is a possibility of an impact scope being predicted to be too small, a retrieving scheme may be determined in accordance with required detection accuracy.

All the information regarding use cases impacted by the requests are transmitted to the display (display unit) of the business impact scope presentation apparatus 100 and are transmitted to the display apparatus 5 via the communication unit 150. Thereafter, the business impact scope presentation apparatus 100 ends the process in this routine.

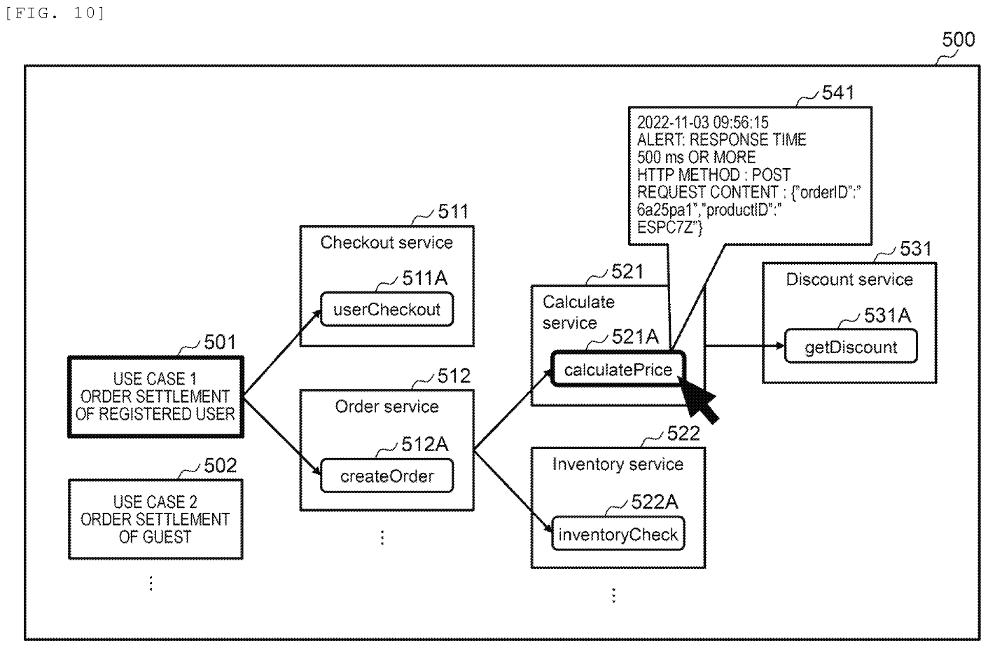

FIG. 10 is a configuration diagram illustrating an example of a display screen of the display apparatus according to Example 1 of the present invention. In FIG. 10, a display screen 500 of the display apparatus 5 is a display screen in which use cases are set as origins. In the display screen 500, a plurality of use cases 501, 502, etc. are displayed. In each use case, a use case list is displayed. At this time, a use case 501 in which an attention is particularly necessary is highlighted and displayed. In an area adjacent to the use case 501, microservices 511, 512, . . . , 521, 522, . . . , and 531 are displayed and API endpoints 511A, 512A, . . . , 521A, 522A, . . . , and 531 respectively belonging to the microservices are displayed. The use case 501, the microservices 511 to 531, and the API endpoints 511A to 531A are displayed in a tree structure based on the use case association information 133.

Here, the display apparatus 5 or the display of the business impact scope presentation apparatus 100 functions as a display unit that displays constituents of the monitoring target software managed in the monitoring target system 1 and adjusts displayed content based on an analysis result of the business impact scope analysis unit 144. For example, the display unit highlights and displays a use case impacted by a request path in which an objective value is not achieved and a request path in which an abnormality occurs among the constituents of the monitoring target software. That is, the API endpoint 521A including the API in which the objective value is not achieved is highlighted and displayed along with the use case 501.

An API request path including the use case 501, the microservice, and the API endpoint is displayed in a tree structure with an arrow. The content of the API request is displayed with a tooltip on each API endpoint. When the highlighted API endpoint 521A is clicked, related information 541 is displayed. As the related information 541, for example, an end time, an alert, an HTTP method, request content, and the like are displayed. In the related information 541, an API monitoring threshold, objective value information, and trace data of a request related to a specific API can also be displayed. Content of image information displayed in the display screen 500 is provided as investigation information to an operational manager.

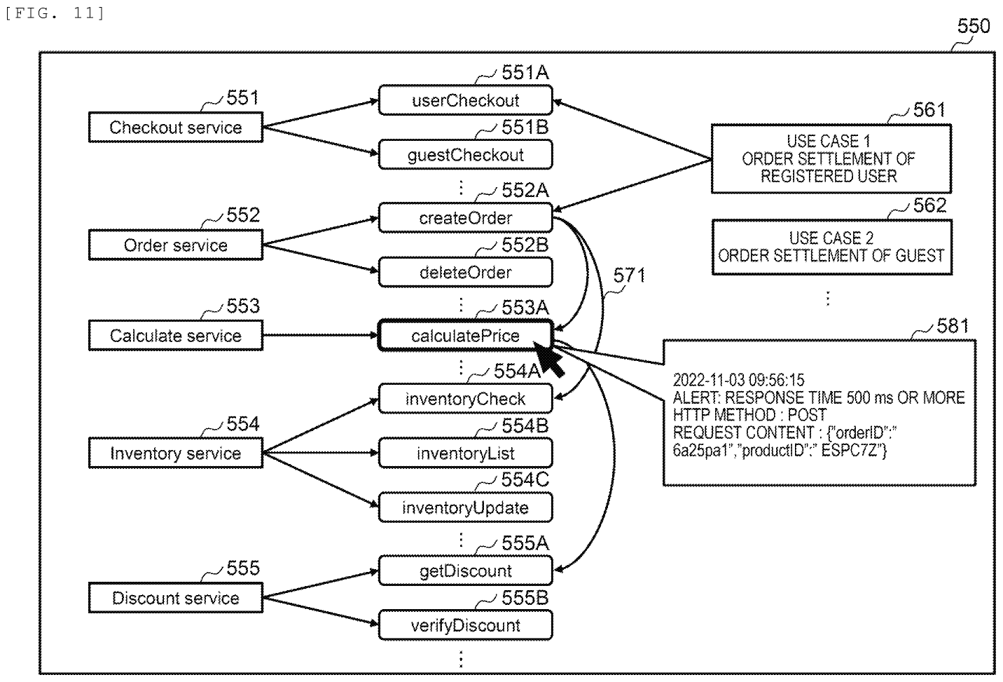

FIG. 11 is a configuration diagram illustrating an example of another display screen of the display apparatus according to Example 1 of the present invention. In FIG. 11, a display screen 550 of the display apparatus 5 is a display screen in which microservices are origins. In the display screen 550, a plurality of microservices 551, 552, 553, 554, and 555 are displayed. In the microservices 551 to 555, a microservice list of the monitoring target system 1 is displayed. In areas adjacent to the microservices 551 to 555, a plurality of API endpoints 551A, 551B, . . . , 552A, 552B, . . . , 553A, . . . , 554A, 554B, 554C, . . . , 555A, 555B, etc. are displayed and a plurality of use cases 561, 562, etc. are displayed. Each of the microservices 551 to 555 and each API endpoint are displayed in a tree structure based on the use case association information 133. The API request path related to the use case is displayed with, for example, an arrow 571 binding API endpoints.

The API point 553A in which the objective value is not achieved is highlighted and displayed. The use case 561 impacted by the API point 553A in which the objective value is not achieved is highlighted and displayed. When the highlighted and displayed API endpoint 553A is clicked, related information 581 is displayed. In the related information 581, for example, an end time, an alert, an HTTP method, request content, and the like are displayed. In the related information 581, an API monitoring threshold, objective value information, and trace data of a request related to a specific API can also be displayed. Content of image information displayed in the display screen 550 is provided as investigation information to an operational manager.

According to this example, when an abnormality occurs in an API request path including a microservice, a use case impacted by the abnormality in the API request path can be specified. According to this example, even when a release of a microservice is fast, a use case impacted by the abnormality in the API request path can be specified. Further, according to this example, a feature of the API request can be ascertained with high accuracy from a test log (test recording information) and the API endpoint in which the objective value is not achieved can be associated with the use case based on the ascertained content. Accordingly, by visualizing an API endpoint in which the objective value related to an important case is not achieved, it is possible to take proactive measures. For example, when performance of the API endpoint associated with the use case deteriorates, the important use case can be normally operated by improving or optimizing the API endpoint. Since the measures can be taken to attain a business objective, an improvement of contribution to business of an IT system can be achieved consequently.

### Example 2

In this example, after an API request in which an objective value is not achieved, it is determined whether a use case is actually impacted by the API request in which an objective value is not achieved or whether there is a possibility that a use case is impacted by the API request in which an objective value is not achieved. Hereinafter, differences from Example 1 will be mainly described. In this example, the configuration of the hardware resources and the configuration of some of the software resources are similar to those of Example 1.

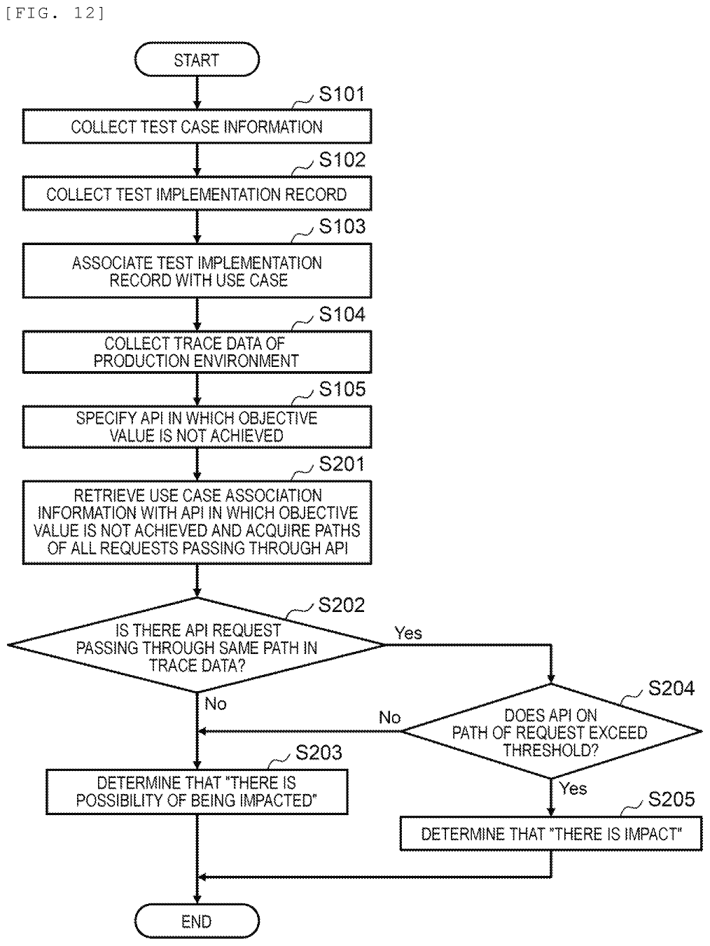

FIG. 12 is a flowchart illustrating a processing example of a business impact scope presentation apparatus according to Example 2 of the present invention. The process is executed by the business impact scope presentation apparatus 100, for example, when an instruction to execute the process is received from the display apparatus 5 via the input unit 110. Differences between the processes of this example and Example 1 are processes after step S201 in which all paths are acquired.

Specifically, in step S105, the business impact scope presentation apparatus 100 specifies an API endpoint in which the objective value is not achieved, and then executes retrieval from the use case association information 133 with the API in which the objective value is not achieved to acquire paths of all the requests passing through the same API as the API in which the objective value is not achieved (step S201). For example, the business impact scope analysis unit 144 extracts all API request paths in which the API endpoint of/calculatePrice is used (an analysis target request path) from the use case association information 133 (see FIG. 6).

Subsequently, the business impact scope analysis unit 144 determines whether there is an API request of the same path as the API endpoint in which the objective value is not achieved in the trace data 135 (see FIG. 8) recorded for a given period (step S202). When there is no API request of the same path as the API in which the objective value is not achieved in the trace data 135 (in the case of “No” in step S202), the process moves to step S203. Since the fact that there is no specific API request in the trace data 135 means that a use case related to the API request has not yet been used, it is determined that “there is a possibility of the use case being subject to an impact” (step S203).

Conversely, when there is the API request of the same path as the API in which the objective value is not achieved in the trace data 135 (in the case of “Yes” in step S202), the process moves to step S204. At this time, the business impact scope analysis unit 144 determines whether a processing time of the API request on the path of the request exceeds a threshold (step S204). Specifically, the business impact scope analysis unit 144 determines whether there is actually an impact of the API in which the objective value is not achieved by determining whether the processing time of the API request on the API request path exceeds the threshold.

When the processing time of the API request on the API request path exceeds the threshold (in the case of “Yes” in step S204), the business impact scope analysis unit 144 determines that “there is the impact” in the use case since a request in which the process is late actually occurs (step S205).

Conversely, when the processing time of the API request on the API request path does not exceed the threshold (in the case of “No” in step S204), the business impact scope analysis unit 144 determines that “there is a possibility of the use case being subject to an impact” since the phenomenon in which the process is late actually has not yet been confirmed (step S203).

In this example, the business impact scope analysis unit 144 extracts all the API request paths including the API request path in which the objective value is not achieved among one or more request paths as the analysis target API request paths with reference to the use case association information 133 based on the API request path in which the objective value is not achieved (S201). Thereafter, the business impact scope analysis unit 144 determines whether there is the analysis target API request When it is determined that path in the trace data 135. there is no analysis target API request path in the trace data 135, the use case related to the microservices connected to the analysis target API request path among the plurality of use cases is analyzed as the use case which is likely to be impacted by the analysis target API request path (S203). When there is the analysis target request path in the trace data 135, the use case related to the microservices connected to the analysis target API request path among the plurality of use cases is analyzed as the use case impacted by the analysis target API request path (S205).

Here, the display apparatus 5 or the display of the business impact scope presentation apparatus 100 functions as a display unit that displays constituents of the monitoring target software managed in the monitoring target system 1 and adjusts displayed content based on an analysis result of the business impact scope analysis unit 144. At this time, for example, the display unit can highlight and display a use case which is likely to be impacted by the request path and a use case impacted by the request path among the constituents of the monitoring target software.

According to this example, it is possible to obtain advantageous effects similar to those of Example 1 and it is possible to separately specify the use cases as the use case actually impacted by the API request in which the objective value is not achieved and the use case likely to be impacted by the API request in which the objective value is not achieved, after specifying the API request in which the objective value is not achieved. According to this example, when the use case actually impacted by the API request in which the objective value is not achieved and the use case likely to be impacted by the API request in which the objective value is not achieved are separately displayed, it is possible to prioritize improvement or optimization of an IT system. For example, for the use case actually impacted by the API request in which the objective value is not achieved, prioritized measures can be taken. For the use case likely to be impacted by the API request in which the objective value is not achieved, preventive measures can be taken from the use case likely to be impacted in the future. Further, by displaying both the fact (the former) and predicted content (the latter), it is possible to clarify the prioritization of the improvement or the optimization of the IT system.

### Example 3

According to this example, when an update occurs in monitoring target software of a monitoring target system, a relation between an API request and a use case is updated. Hereinafter, differences from Example 1 will be mainly described. In this example, the configuration of the hardware resources and the configuration of some of the software resources are similar to those of Example 1.

When an update occurs in the monitoring target software of the monitoring target system 1, a relation between an API and a use case is likely to be changed with a change in specifications of the API. Therefore, it is necessary to appropriately update the relation between the API and the use case. At this time, the update information acquisition unit 145 is an update information acquisition program that collects update information of the monitoring target system 1 and determines whether to start a use case association process. Specifically, the update information acquisition unit 145 collects the update information and a test implementation situation from a CI/CD tool of the monitoring target system 1, generates update information 136, and stores the generated update information 136 in the storage unit 130. At this time, when an update occurs in the monitoring target software of the monitoring target system 1 and the test apparatus 2 completes a test, the update information acquisition unit 145 notifies the test log collection unit 141 of information indicating that the update occurs in the monitoring target software of the monitoring target system 1.

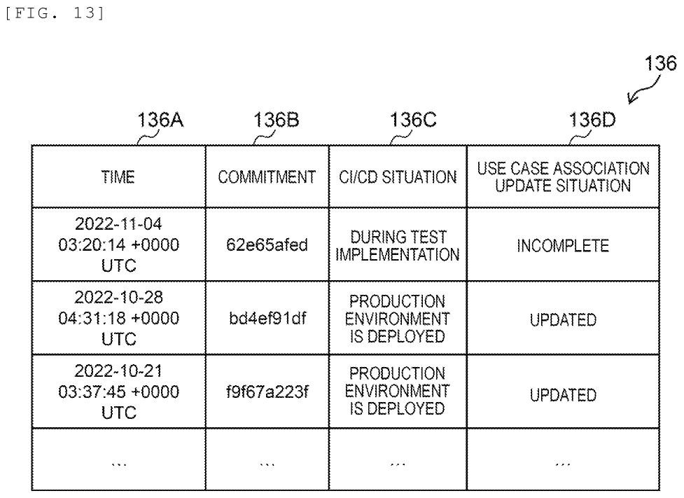

FIG. 13 is a configuration diagram illustrating a configuration example of update information according to Example 3 of the present invention. In FIG. 13, the update information 136 is information for managing a test implementation situation and a deployment situation of an application of a new version among monitoring target software used in the monitoring target system 1, and includes a time 136A, a commitment 136B, a CI/CD situation 136C, and a use case association update situation 136D.

The time 136A is a time at which the application of the new version is provided to the monitoring target system 1. In the time 136A, for example, when 3:20:14 on Nov. 4, 2022 (coordinate universal time) is a time at which the application of the new version is provided, information “2022-11-04 03:20:14” is recorded. The commitment 136B is an identification number of a code base update record. In the commitment 136B, for example, information “62e65afed” is recorded. The CI/CD situation 136C s a test implementation situation or a deployment situation of the application of the new version. In the CI/CD situation 136C, for example, when a test of the application of the new version is being executed, information “During test implementation” is recorded. When the application of the new version is deployed in a production environment, information “Production environment is deployed” is recorded. A use case association update situation 136E is a flag indicating whether the use case association information 133 is in the latest state for the application of the new version. In the use case association update situation 136E, for example, when the use case association information 133 is not in the latest state, information “Incomplete” is recorded as a flag. When the use case association information 3 is in the latest state, information “Updated” is recorded as a flag.

Here, for example, the first record of the update information 136 indicates that “Update of the commitment identification number 62e65afed occurs at the time “2022-11-04 03:20:14” and use case association information has not yet been updated during implementation of the test by the CI/CD tool“.

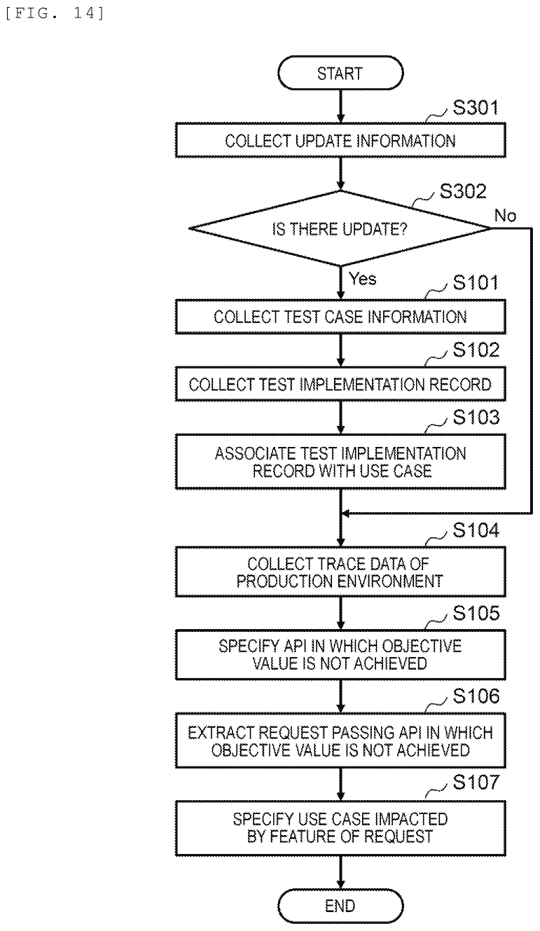

FIG. 14 is a flowchart illustrating a processing example of a business impact scope presentation apparatus according to Example 3 of the present invention. The process is executed by the business impact scope presentation apparatus 100, for example, when an instruction to execute a process is received from the display apparatus 5 via the input unit 110. Differences between the processes of this example and Example 1 are that a step (step S301) of collecting update information and a step (step S302) of determining whether there is an update are added before step S101.

Specifically, the update information acquisition unit 145 of the business impact scope presentation apparatus 100 collects the update information from the CI/CD tool of the monitoring target system 1, generates the update information 136, and stores the generated update information 136 in the storage unit 130 (step S301).

Subsequently, the update information acquisition unit 145 determines whether there is an update in the monitoring target software (application) of the monitoring target system 1 (step S302). When it is determined that there is the update, for example, new commitment occurs and the use case association has not yet been updated (in the case of “Yes” in step S302), the update information acquisition unit 145 moves to the process of step S101 which is a process by the test log collection unit 141 and ends the process in this routine. At this time, under the condition that there is the update in the monitoring target software of the monitoring target system 1 and the update of the use case association information 133 has not been completed, the update information acquisition unit 145 instructs the test log collection unit 141 and the use case association unit 142 to execute an update process associated with the update (S101 to S103). Accordingly, the use case association information 133 is updated to the latest state by the use case association unit 142 (S103).

Conversely, when it is determined that there is no update and, for example, when there is no new commitment (in the case of “No” in step S302), it is not necessary for the update information acquisition unit 145 to update the use case association information. Therefore, the monitoring information acquisition unit 143 moves to step S104 which is a process of the monitoring information acquisition unit 143 and ends the process in this routine.

According to this example, when an update occurs in the monitoring target software of the monitoring target system, it is possible to update the relation between the API requests and the use cases. For example, the use case association information can be normally updated to the latest information with an update of agile development. According to this example, by collecting update information automatically, it is possible to exclude omission of confirmation of an updated version of an application. Accordingly, the use case association information enters a normally reliable state of the latest. As a result, it is possible to accurately specify the use case impacted by the request path in which an abnormality occurs, and it is possible to contribute to improvement of accuracy.

The present invention is not limited to the above-described examples, various modifications but and equivalent configurations are included within the gist of the scope of the appended claims. For example, the above-described examples have been described in detail to facilitate the description of the present invention and the present invention is not necessarily limited to all the described configurations.

Some or all of the above-described configurations, functions, and the like may be realized by hardware, for example, by design or the like of integrated circuits or may be realized by software by interpreting and executing a program used for a processor to realize each function.

Information regarding a program, a table, a file, or the like for realizing each function can be stored in a storage device such as a memory, a hard disk, a solid state drive (SSD) or a recording medium such as an integrated circuit (IC) card, a secure digital (SD) card, or a digital versatile disc (DVD).

### REFERENCE SIGNS LIST

1: monitoring target system
2: test apparatus
3: monitoring apparatus
4: network
5: display apparatus
100: business impact scope presentation apparatus
110: input unit
120: output unit
130: storage unit
131: test case information
132: test recording information
133: use case association information
134: monitoring item and objective value information
135: trace data
136: update information
140: calculation unit
141: test log collection unit
142: use case association unit
143: monitoring information acquisition unit
144: business impact scope analysis unit
145: update information acquisition unit
150: communication unit

1. A business impact scope presentation apparatus comprising:
a test log collection unit configured to collect test recording information indicating an implementation result of a test for monitoring target software in which one or more operational steps indicating constituents of content of a plurality of businesses and a plurality of microservices executing processes through operations of the one or more operational steps are connected via one or more request paths, and collect test case information indicating a relation between the content of each of the businesses and each of the operational steps;
a use case association unit configured to generate use case association information by associating the content of each of the businesses with a request path corresponding to each of the operational steps of the one or more request paths based on the test recording information and the test case information collected by the test log collection unit;
a monitoring information acquisition unit configured to acquire trace data indicating an implementation result of each of the microservices as an implementation result in a production environment for the monitoring target software; and
a business impact scope analysis unit configured to determine whether an abnormality occurs in one request path among the one or more request paths based on the trace data acquired by the monitoring information acquisition unit,
wherein, when it is determined that the abnormality occurs in the one request path, the business impact scope analysis unit specifies the content of the business impacted by the request path in which the abnormality occurs among the content of each of the businesses with reference to the use case association information based on the request path in which the abnormality occurs.

2. The business impact scope presentation apparatus according to claim 1,
wherein the trace data includes, as a processing time required in a process for each request by each of the operational steps and each of the microservices, a processing time of the each request in each of the request paths, and
wherein the business impact scope analysis unit compares the processing time of the each request with a set threshold with reference to the trace data, determines that the abnormality occurs when the processing time of one request exceeds the threshold, and analyzes a request path of the request in which the processing time exceeds the threshold as a request path which is a request path in which the abnormality occurs and in which an objective value is not achieved.

3. The business impact scope presentation apparatus according to claim 2, wherein the business impact scope analysis unit extracts, as analysis target request paths, all request paths in which the objective value is not achieved among the one or more request paths with reference to the use case association information based on the request path in which the objective value is not achieved.

4. The business impact scope presentation apparatus according to claim 3, wherein the business impact scope analysis unit
determines whether there is the analysis target request path in the trace data,
analyzes content of a business related to the microservice connected to the analysis target request path among the content of each of the businesses as content of a business likely to be impacted by the analysis target request path when it is determined that there is no analysis target request path in the trace data, and
analyzes the content of the business related to the microservice connected to the analysis target request path among the content of each of the businesses as content of a business impacted by the analysis target request path when it is determined that there is the analysis target request path in the trace data.

5. The business impact scope presentation apparatus according to claim 2, further comprising:
a display unit configured to display constituents of the monitoring target software and adjust displayed content based on an analysis result of the business impact scope analysis unit,
wherein the display unit emphasizes and displays content of a business impacted by a request path in which the objective value is not achieved and a request path in which the abnormality occurs among the constituents of the monitoring target software.

6. The business impact scope presentation apparatus according to claim 4, further comprising:
a display unit configured to display constituents of the monitoring target software and adjust displayed content based on an analysis result of the business impact scope analysis unit,
wherein the display unit emphasizes and displays content of a business likely to be impacted by the analysis target request path and content of a business impacted by the analysis target request path among the constituents of the monitoring target software.

7. The business impact scope presentation apparatus according to claim 1, further comprising:
an update information acquisition unit configured to acquire update information including whether the monitoring target software is updated and whether the use case association information is updated,
wherein the update information acquisition unit instructs the test log collection unit and the use case association unit to execute an update process associated with the update under conditions that there is an update for the monitoring target software and the update of the use case association information is not completed.

8. A business impact scope presentation method that is a method using a computer, the method comprising:
a test log collection step in which the computer collects test recording information indicating an implementation result of a test for monitoring target software in which one or more operational steps indicating constituents of content of a plurality of businesses and a plurality of microservices executing processes through operations of the one or more operational steps are connected via one or more request paths, and collects test case information indicating a relation between the content of each of the businesses and each of the operational steps;
a use case association step in which the computer generates use case association information by associating the content of each of the businesses with a request path corresponding to each of the operational steps of the one or more request paths based on the test recording information and the test case information collected in the test log collection step;
a monitoring information acquisition step in which the computer acquires trace data indicating an implementation result of each of the microservices as an implementation result in a production environment for the monitoring target software; and
a business impact scope analysis step in which the computer determines whether an abnormality occurs in one request path among the one or more request paths based on the trace data acquired in the monitoring information acquisition step,
wherein, when it is determined that the abnormality occurs in the one request path, in the business impact scope analysis step, the computer specifies the content of the business impacted by the request path in which the abnormality occurs among the content of each of the businesses with reference to the use case association information based on the request path in which the abnormality occurs.

9. The business impact scope presentation method according to claim 8,
wherein the trace data includes, as a processing time required in a process for each request by each of the operational steps and each of the microservices, a processing time of the each request in each of the request paths, and
wherein, in the business impact scope analysis step, the computer compares the processing time of the each request with a set threshold with reference to the trace data, determines that the abnormality occurs when the processing time of one request exceeds the threshold, and analyzes a request path of the request in which the processing time exceeds the threshold as a request path which is a request path in which the abnormality occurs and in which an objective value is not achieved.

10. The business impact scope presentation method according to claim 9, wherein, in the business impact scope analysis step, the computer extracts, as analysis target request paths, all request paths in which the objective value is not achieved among the one or more request paths with reference to the use case association information based on the request path in which the objective value is not achieved.

11. The business impact scope presentation method according to claim 10, wherein, in the business impact scope analysis step, the computer
determines whether there is the analysis target request path in the trace data,
analyzes content of a business related to the microservice connected to the analysis target request path among the content of the businesses as content of a business likely to be impacted by the analysis target request path when it is determined that there is no analysis target request path in the trace data, and
analyzes the content of the business related to the microservice connected to the analysis target request path among the content of the businesses as content of a business impacted by the analysis target request path when it is determined that there is the analysis target request path in the trace data.

12. The business impact scope presentation method according to claim 9, further comprising:
a display step in which the computer displays constituents of the monitoring target software and adjusts displayed content based on an analysis result of the business impact scope analysis step,
wherein, in the display step, the computer emphasizes and displays content of a business impacted by a request path in which the objective value is not achieved and a request path in which the abnormality occurs among the constituents of the monitoring target software.

13. The business impact scope presentation method according to claim 11, further comprising:
a display step in which the computer displays constituents of the monitoring target software and adjusts displayed content based on an analysis result of the business impact scope analysis step,
wherein, in the display step, the computer emphasizes and displays content of a business likely to be impacted by the analysis target request path and content of a business impacted by the analysis target request path among the constituents of the monitoring target software.

14. The business impact scope presentation method according to claim 8, further comprising:
an update information acquisition step in which the computer acquires update information including whether the monitoring target software is updated and whether the use case association information is updated,
wherein, in the update information acquisition step, the computer instructs the test log collection step and the use case association step to execute an update process associated with the update under conditions that there is an update for the monitoring target software and the update of the use case association information is not completed.
